(19) United States
(12) Patent Application Publication
(10) Pub. No.: US 2024/0163935 A1
(43) Pub. Date: May 16, 2024

(54) TECHNIQUES FOR RADIO RESOURCE CONTROL MESSAGE DELIVERY AND CONFIGURATION FOR REMOTE USER EQUIPMENT

(71) Applicant: QUALCOMM Incorporated, San Diego, CA (US)

(72) Inventors: Peng CHENG, Beijing (CN); Karthika PALADUGU, Hyderabad, Telangana (IN); Hong CHENG, Basking RIdge, NJ (US)

(21) Appl. No.: 18/284,280

(22) PCT Filed: May 6, 2021
(86) PCT No.: PCT/CN2021/091840

§ 371 Date: Sep. 26, 2023

(51) Int. Cl. H04W 76/10; H04W 88/04

(52) U.S. Cl. CPC H04W 76/10; H04W 88/04

(57) ABSTRACT

Techniques for RRC message delivery configuration for remote UEs may include, for example, a remote UE transmitting a request, to a relay UE, to establish a connection with a base station. The relay UE may determine a state (e.g., idle or connected) of the relay UE and, based on the state, may forward the request to the base station and receive a response to the request via a Uu radio link control (RLC) channel for relaying communications between the remote UE and the base station.

### TECHNICAL FIELD

Aspects of the present disclosure relate generally to wireless communications, and more particularly, to techniques for radio resource control message delivery and configuration for remote user equipment.

### BACKGROUND

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired. For example, improvements in specifying control plane procedures for a remote user equipment (UE) are desired.

### SUMMARY

Systems, methods, and apparatus presented herein each have several innovative aspects, no single one of which is solely responsible for the desirable attributes disclosed herein. The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication for a relay user equipment (UE) is provided. The method may include receiving, from a remote UE, a request message for establishing or resuming a connection between the remote UE and a base station. The method may also include determining a radio link control (RLC) channel to relay communications between the remote UE and the base station in response to the request message. The method may also include relaying the communications between the remote UE and the base station on the RLC channel in response to determining the RLC channel.

In an aspect, a method of wireless communication for a base station is provided. The method may also include receiving, from a relay UE, an indication of a request message for establishing or resuming a connection between a remote UE and a base station. The method may also include determining an RLC channel to relay communications between the remote UE and the base station via the relay UE, in response to the request message. The method may also include communicating, via the relay UE, with the remote UE on the RLC channel, in response to determining the RLC channel.

In other aspects, apparatuses and computer-readable mediums for performing the above-disclosed methods are provided.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network, according to aspects of the present disclosure;

FIG. 2 is a schematic diagram of an example of a user equipment (UE) of FIG. 1, according to aspects of the present disclosure;

FIG. 3 is a schematic diagram of an example of a base station of FIG. 1, according to aspects of the present disclosure;

FIG. 4 is a call flow diagram of example wireless communications between UEs and a base station of FIG. 1, according to aspects of the present disclosure;

FIG. 5 is a block diagram of example protocol stacks used by the UEs and base stations of FIG. 1, according to aspects of the present disclosure;

FIG. 6 is another call flow diagram of example wireless communications between UEs and a base station of FIG. 1, according to aspects of the present disclosure;

FIG. 7 is a diagram of an example information element used for wireless communications between UEs and a base station of FIG. 1, according to aspects of the present disclosure;

FIG. 8 is another call flow diagram of example wireless communications between UEs and a base station of FIG. 1, according to aspects of the present disclosure;

FIG. 9 is another call flow diagram of example wireless communications between UEs and a base station of FIG. 1, according to aspects of the present disclosure;

FIG. 10 is another call flow diagram of example wireless communications between UEs and a base station of FIG. 1, according to aspects of the present disclosure;

FIG. 11 is flowchart of an example method performed by the UE of FIG. 1, according to aspects of the present disclosure; and

FIG. 12 is flowchart of another example method performed by the base station of FIG. 1, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A remote user equipment (UE) may be defined as a UE that does not have a direct communication link with a base station, while a relay UE may be defined as a UE that has a direct communication link to a base station and relays communications between the remote UE and the base station. For example, during a radio resource control (RRC) establishment procedure between a remote UE and a base station, a sidelink (SL) connection between the remote UE and a relay UE may initially be established, and the relay UE may be configured to relay messages between the remote UE and the base station. However, conventional techniques may not include operations for communicating some types of messages such as RRC messages between the remote UE and the base station.

Aspects of the present disclosure provide techniques for RRC message delivery configuration for remote UEs. For example, a remote UE may transmit a request, to a relay UE, to establish a connection with a base station. The relay UE may determine a state (e.g., idle or connected) of the relay UE and, based on the state, may forward the request to the base station and receive a response to the request via a type of radio link control (RLC) channel for relaying communications between the remote UE and the base station.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Turning now to the figures, examples of systems, apparatus, and methods according to aspects of the present disclosure are depicted. It is to be understood that aspects of the figures may not be drawn to scale and are instead drawn for illustrative purposes.

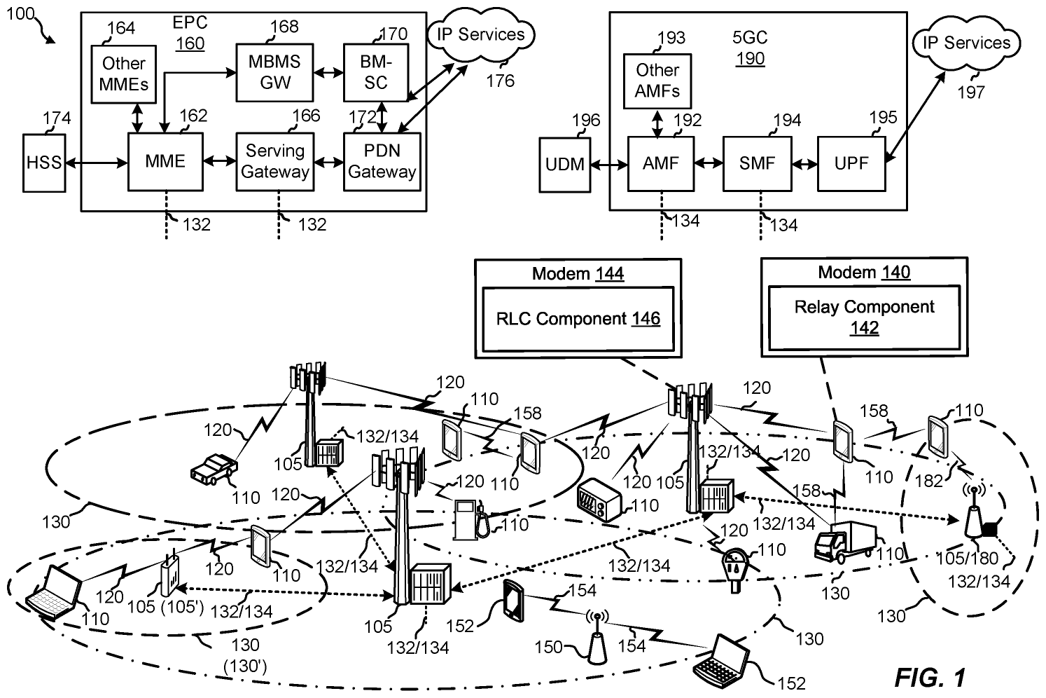

FIG. 1 is a diagram illustrating an example of a wireless communications system and an access network 100. The wireless communications system (also referred to as a wireless wide area network (WWAN)) includes at least one base station 105, at least one UE 110, at least one Evolved Packet Core (EPC) 160, and at least one 5G Core (5GC) 190. The base station 105 may include macro cells (high power cellular base station) and/or small cells (low power cellular base station). The macro cells include base stations. The small cells include femtocells, picocells, and microcells.

In an example, a UE 110 (e.g., relay UE) may include a modem 140 and/or a relay component 142 for relaying communications between the base station 105 and a remote UE 110 via an RLC channel. In another example, a base station 105 may include a modem 144 and/or an RLC component 146 for configuring a relay UE 110 to relay communications between the base station 105 and a remote UE 110 via an RLC channel.

A base station 105 may be configured for 4G LTE (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A base station 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the base station 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base station 105 may communicate directly or indirectly (e.g., through the EPC 160 or 5GC 190) with each other over the backhaul links interfaces 134. The backhaul links 132, 134 may be wired or wireless.

The base station 105 may wirelessly communicate with the UEs 110. Each of the base station 105 may provide communication coverage for a respective geographic coverage area 130. There may be overlapping geographic coverage areas 130. For example, the small cell 105′ may have a coverage area 130′ that overlaps the coverage area 130 of one or more macro base station 105. A network that includes both small cell and macro cells may be known as a heterogeneous network. A heterogeneous network may also include Home Evolved Node base station (eNBs) (HeNBs), which may provide service to a restricted group known as a closed subscriber group (CSG). The communication links 120 between the base station 105 and the UEs 110 may include uplink (UL) (also referred to as reverse link) transmissions from a UE 110 to a base station 105 and/or downlink (DL) (also referred to as forward link) transmissions from a base station 105 to a UE 110. The communication links 120 may use multiple-input and multiple-output (MIMO) antenna technology, including spatial multiplexing, beamforming, and/or transmit diversity. The communication links may be through one or more carriers. The base station 105/UEs 110 may use spectrum up to Y MHz (e.g., 5, 10, 15, 20, 100, 400, etc. MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more SL channels, such as a physical SL broadcast channel (PSBCH), a physical SL discovery channel (PSDCH), a physical SL shared channel (PSSCH), and a physical SL control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A base station 105, whether a small cell 105′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 110. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base station 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a repeater, a transceiver function, a basic service set (BSS), an extended service set (ESS), a transmit reception point (TRP), or some other suitable terminology. The base station 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

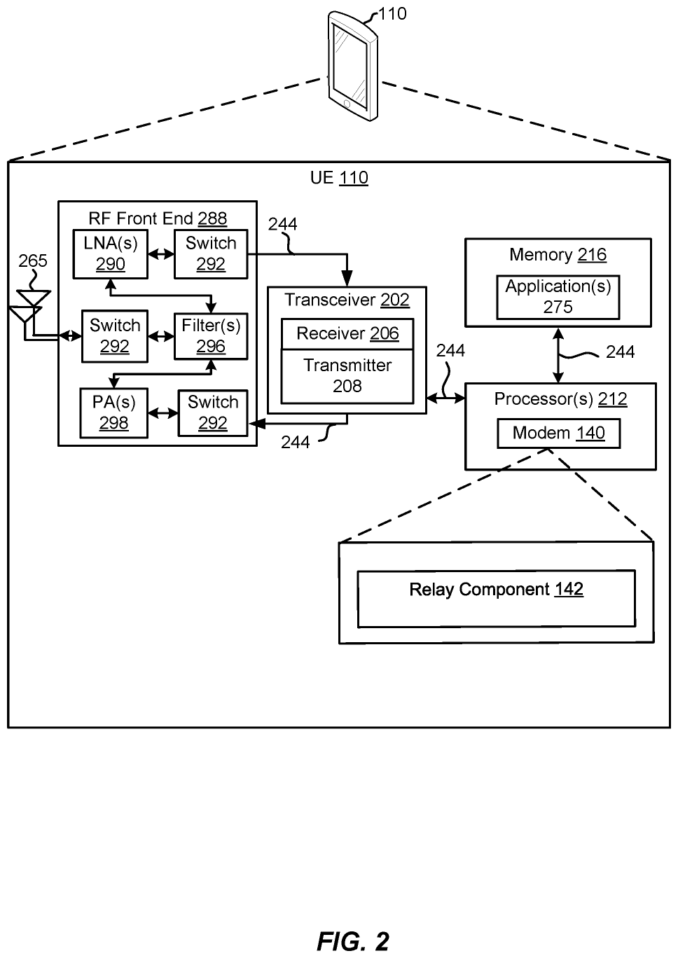

Referring to FIG. 2, an example implementation of a UE 110 may include the modem 140 having the relay component 142. The modem 140 and/or the relay component 142 of the UE 110 may be configured to relay communications between the base station 105 and a remote UE 110, as described in further detail herein.

In some implementations, the UE 110 may include a variety of components, including components such as one or more processors 212 and memory 216 and transceiver 202 in communication via one or more buses 244, which may operate in conjunction with the modem 140 and/or the relay component 142 to enable one or more of the functions, described herein. Further, the one or more processors 212, modem 140, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 140 that uses one or more modem processors. The various functions related to the relay component 142 may be included in the modem 140 and/or the processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 140 may configure the UE 110 along with the processors 212. In other aspects, some of the features of the one or more processors 212 and/or the modem 140 associated with the relay component 142 may be performed by the transceiver 202.

Also, the memory 216 may be configured to store data used herein and/or local versions of applications 275 or the relay component 142 and/or one or more subcomponents of the relay component 142 being executed by at least one processor 212. The memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, the memory 216 may be a non-transitory computer-readable storage medium that stores one or more computer-executable codes defining the relay component 142 and/or one or more of its subcomponents, and/or data associated therewith, when the UE 110 is operating at least one processor 212 to execute the relay component 142 and/or one or more of the subcomponents.

The transceiver 202 may include at least one receiver 206 and at least one transmitter 208. The receiver 206 may include hardware, firmware, and/or software code executable by a processor for receiving data, the code comprising instructions and being stored in a memory (e.g., computer-readable medium). The receiver 206 may be, for example, an RF receiving device. In an aspect, the receiver 206 may receive signals transmitted by at least one base station 105. The transmitter 208 may include hardware, firmware, and/or software code executable by a processor for transmitting data, the code comprising instructions and being stored in a memory (e.g., computer-readable medium). A suitable example of the transmitter 208 may include, but is not limited to, an RF transmitter.

Moreover, in an aspect, the UE 110 may include the RF front end 288, which may operate in communication with one or more antennas 265 and the transceiver 202 for receiving and transmitting radio transmissions, for example, wireless communications transmitted by at least one base station 105 or wireless transmissions transmitted by the UE 110. The RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, the LNA 290 may amplify a received signal at a desired output level. In an aspect, each of the LNAs 290 may have a specified minimum and maximum gain values. In an aspect, the RF front end 288 may use one or more switches 292 to select a particular LNA 290 and the specified gain value based on a desired gain value for a particular application.

Further, for example, one or more PA(s) 298 may be used by the RF front end 288 to amplify a signal for an RF output at a desired output power level. In an aspect, each of the PAs 298 may have specified minimum and maximum gain values. In an aspect, the RF front end 288 may use one or more switches 292 to select a particular PA 298 and the specified gain value based on a desired gain value for a particular application.

Also, for example, one or more filters 296 may be used by the RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, the RF front end 288 may use one or more switches 292 to select a transmit or receive path using a specified filter 296, the LNA 290, and/or the PA 298, based on a configuration as specified by the transceiver 202 and/or processor 212.

As such, the transceiver 202 may be configured to transmit and receive wireless signals through one or more antennas 265 via the RF front end 288. In an aspect, the transceiver 202 may be tuned to operate at specified frequencies such that the UE 110 may communicate with, for example, one or more of the UEs 110, one or more of the base stations 105, or one or more cells associated with one or more of the base stations 105. In an aspect, for example, the modem 140 may configure the transceiver 202 to operate at a specified frequency and power level based on a control entity configuration of the UE 110 and the communication protocol used by the modem 140.

In an aspect, the modem 140 may be a multiband-multimode modem, which may process digital data and communicate with the transceiver 202 such that the digital data is sent and received using the transceiver 202. In an aspect, the modem 140 may be multiband and be configured to support multiple frequency bands for a specific communications protocol. In an aspect, the modem 140 may be multimode and be configured to support multiple operating networks and communications protocols. In an aspect, the modem 140 may control one or more components of the UE 110 (e.g., RF front end 288, transceiver 202) to enable transmission and/or reception of signals from the network based on a specified modem configuration. In an aspect, a modem configuration may be based on the mode of the modem 140 and the frequency band in use. In another aspect, the modem configuration may be based on control entity configuration information associated with the UE 110 as provided by the network (e.g., base station 105).

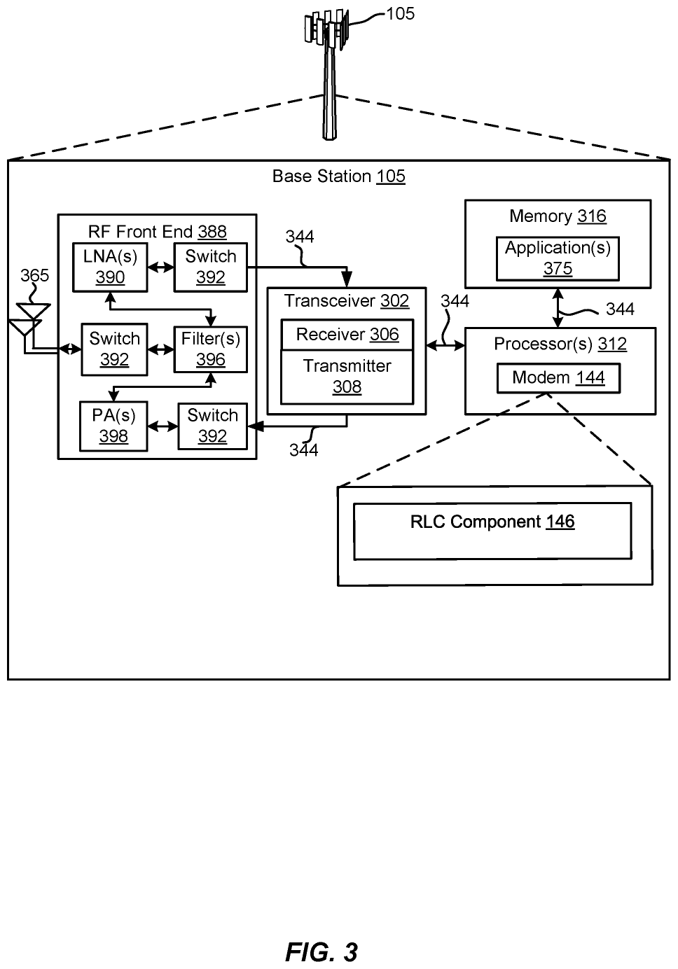

Referring to FIG. 3, an example implementation of a base station 105 may include a modem 144 having the RLC component 146. The modem 144 and/or the RLC component 146 of the base station 105 may be configured to configure a relay UE 110 to relay communications between the base station 105 and a remote UE 110, as described in further detail herein.

In some implementations, the base station 105 may include a variety of components, including components such as one or more processors 312 and memory 316 and transceiver 302 in communication via one or more buses 344, which may operate in conjunction with the modem 144 to enable one or more of the functions, described herein. Further, the one or more processors 312, the modem 144, the memory 316, the transceiver 302, a RF front end 388, and one or more antennas 365, may be configured to support voice and/or data calls (simultaneously or non-simultaneously) in one or more radio access technologies. The one or more antennas 365 may include one or more antennas, antenna elements and/or antenna arrays.

In an aspect, the one or more processors 312 may include the modem 144 that uses one or more modem processors. The various functions of the modem 144 and/or the processors 312 may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with the transceiver 302. Additionally, the modem 144 may configure the base station 105 and the processors 312. In other aspects, some of the features of the one or more processors 312 and/or the modem 144 may be performed by the transceiver 302.

Also, the memory 316 may be configured to store data used herein and/or local versions of applications 375, and/or one or more subcomponents of the modem 144 being executed by at least one processor 312. The memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, the memory 316 may be a non-transitory computer-readable storage medium that stores one or more computer-executable codes defining the modem 144 and/or one or more of the subcomponents, and/or data associated therewith, when the base station 105 is operating at least one processor 312 to execute the modem 144 and/or one or more of the subcomponents.

The transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, an RF receiving device. In an aspect, the receiver 306 may receive signals transmitted by the UE 110. The transmitter 308 may include hardware, firmware, and/or software code executable by a processor for transmitting data, the code comprising instructions and being stored in a memory (e.g., computer-readable medium). A suitable example of the transmitter 308 may include, but is not limited to, an RF transmitter.

Moreover, in an aspect, the base station 105 may include the RF front end 388, which may operate in communication with one or more antennas 365 and the transceiver 302 for receiving and transmitting radio transmissions, for example, wireless communications transmitted by the base stations 105 or wireless transmissions transmitted by the UEs 110. The RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, the LNA 390 may amplify a received signal at a desired output level. In an aspect, each of the LNAs 390 may have a specified minimum and maximum gain values. In an aspect, the RF front end 388 may use one or more switches 392 to select a particular LNA 390 and the specified gain value based on a desired gain value for a particular application.

Further, for example, one or more PA(s) 398 may be used by the RF front end 388 to amplify a signal for an RF output at a desired output power level. In an aspect, each PA 398 may have specified minimum and maximum gain values. In an aspect, the RF front end 388 may use one or more switches 392 to select a particular PA 398 and the specified gain value based on a desired gain value for a particular application.

Also, for example, one or more filters 396 may be used by the RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, the RF front end 388 may use one or more switches 392 to select a transmit or receive path using a specified filter 396, the LNA 390, and/or the PA 398, based on a configuration as specified by the transceiver 302 and/or the processor 312.

As such, the transceiver 302 may be configured to transmit and receive wireless signals through one or more antennas 365 via the RF front end 388. In an aspect, the transceiver 302 may be tuned to operate at specified frequencies such that the base station 105 may communicate with, for example, the UEs 110, the base station 105, or one or more cells associated with one or more of the base station 105. In an aspect, for example, the modem 144 may configure the transceiver 302 to operate at a specified frequency and power level based on the repeater configuration of the base station 105 and the communication protocol used by the modem 144.

In an aspect, the modem 144 may be a multiband-multimode modem, which may process digital data and communicate with the transceiver 302 such that the digital data is sent and received using the transceiver 302. In an aspect, the modem 144 may be multiband and be configured to support multiple frequency bands for a specific communications protocol. In an aspect, the modem 144 may be multimode and be configured to support multiple operating networks and communications protocols. In an aspect, the modem 144 may control one or more components of the base station 105 (e.g., RF front end 388, transceiver 302) to enable transmission and/or reception of signals from the network based on a specified modem configuration. In an aspect, the modem configuration may be based on the mode of the modem 144 and the frequency band in use. In another aspect, the modem configuration may be based on a repeater configuration associated with the base station 105.

The present disclosure may describe solutions to enable layer-2 based UE-to-Network (U2N) relaying including RRC connection management. Such solutions may include utilization of single-hop, sidelink-based, communications between a relay UE and a remote UE. In an example, techniques for configuring an RLC channel for delivering a remote UE's Uu (e.g., UE-to-base station connection) signal radio bearer (SRB) message (e.g., SRB0 or SRB1 message) may be provided.

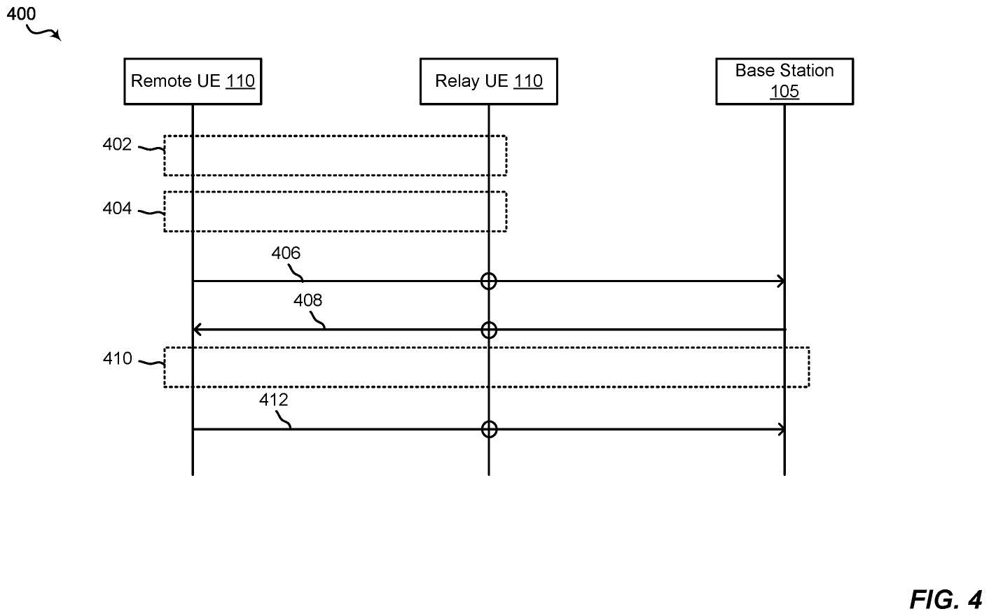

Referring to FIG. 4, example operations for an RRC establishment procedure 400 between a remote UE 110 and a base station 105, using a relay UE 110, may be performed. In an example, the remote UE 110 and the relay UE 110 may initialize discovery operations 402 in order to discovery each other for communications. In response to the discovery operations 402, sidelink (SL) establishment operations 404 may then be performed to setup a SL connection between the remote UE 110 and the relay UE 110.

After the SL connection, the remote UE 110 may perform setup operations for establishing a connection with the base station 105 via the relay UE 110. For example, the remote UE 110 may send a request message 406 (e.g., RRC setup request) to the base station 105 via the relay UE 110. In an example, the request message 406 may be sent using a default L2 configuration on the SL connection between the remote UE and the relay UE 110. In an example, if the relay UE 110 is in an idle state or an inactive state (e.g., not in an RRC connected state) upon receiving the request message 406, the relay UE 110 would may perform a trigger service request procedure for relaying communications. During the trigger service request procedure, the relay UE 110 in idle state or inactive state (e.g., CM_IDLE state) may be triggered to perform a connection establishment or a connection resumption with the base station 105. A new establishment or resume cause value (e.g., for RelayRRCSetuup) may be indicated in a connection establishment/resume request message by the relay UE 110. In response to the request message 406, the base station 105 may transmit a setup message 408 (e.g., RRC setup message). In an example, the setup message 408 may be sent to the remote UE 110 via the relay UE 110 using a default configuration on the SL connection.

When the remote UE 110 receives the setup message 408, the remote UE 110 and the base station 105 may perform RLC channel preparations 410 for preparing an SL and Uu RLC channel for communicating via the relay UE 110. Further, the remote UE 110 may send a setup complete message 412 (e.g., RRC setup complete) to the base station 105 via the relay UE 110 to confirm that the setup of the connection between the remote UE 110 and the base station 105 is complete, thereby implementing the relay UE 110 to relay communications between the UE 110 and the base station 105.

In an aspect, the relay UE 110 and the remote UE 110 may use a specified configuration for an SL (or PC5) RLC channel for a first SRB message (e.g., SRB0), and a default configuration for an SL RLC channel for a second SRB message (e.g., SRB1—RRC resume message and RRC reestablishment message).

In another aspect, for the delivery of the first SRB message by the remote UE 110, a specified (or fixed) configuration may be used for configuration of the SL RLC channel.

In another example, for the delivery of the second SRB message by the remote UE 110, other than the RRC resume message and the RRC reestablishment message, a network configuration via dedicated signaling may be used for the configuration of the SL RLC channel and the Uu RLC channel.

In another example, for the delivery of the second SRB message by the remote UE 110, such as the RRC resume message and the RRC reestablishment message, a default configuration may used for the configuration of the SL RLC channel which can be reconfigured by the base station 105.

In this disclosure, the phrase “specified configuration” may indicate a configuration that may not be reconfigured by the network (e.g., base station 105) and the phrase “default configuration” may indicate a configuration that may be reconfigured (e.g., mapped to SRB1 delivery) by the network.

While the above example includes general procedures for establishing connections between remote UE 110 and the base station 105, via the relay UE, the present disclosure provides detailed examples of these procedures including techniques for configuring the Uu RLC channel.

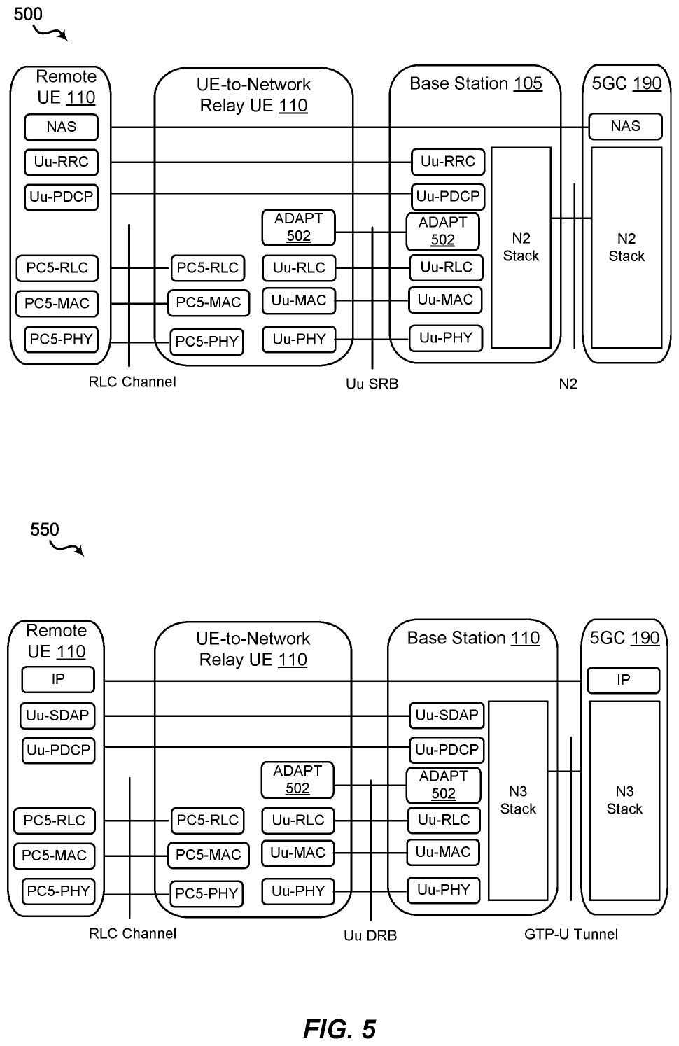

Referring to FIG. 5, examples of a control lane protocol stack 500 and a user plane protocol stack 550 for the remote UE 110, the relay UE 110, the base station 105, and the 5GC 190, are provided. As illustrated, a number of layers exist between each of the devices including PC5 (or SL) layers (e.g., layers between two UEs) and Uu layers (e.g., layers between UE and base station). In an example, for both the control lane protocol stack 500 and the user plane protocol stack 550, an adaptation layer (“adapt”) 502 may be used to multiplex multiple PC5 RLC channels into a single Uu RLC channel.

In an aspect, for both DL and UL transmission of Uu radio bearers, other than an SRB0 message, identity information of the remote UE 110 and the Uu radio bearer of the remote UE 110 may be included in a header of the adaptation layer 502 over Uu.

In another aspect, the radio bearer identification in the header of the adaptation layer 502 may be the Uu radio bearer identification of the remote UE 110.

In another aspect, the UE identification in the header of the adaptation layer 502 may be a local, temporary remote UE identification.

Aspects of the present disclosure provide techniques for providing use of the header of the adaptation layer 502 for DL and UL transmission of Uu radio bearers including an SRB0 message. In another aspect, techniques for making the presence of the header of the adaptation layer 502 configurable are provided. In another aspect, techniques for assigning a local, temporary remote UE identification by the relay UE 110, or by the serving base station 105 of the relay UE 110, are also provided. These techniques may include a case where the relay UE 110 is in an idle or inactive state upon reception of the SRB0 message from the remote UE 110, and/or a case where the relay UE 110 is in a connected state upon reception of the SRB0 message from the remote UE 110.

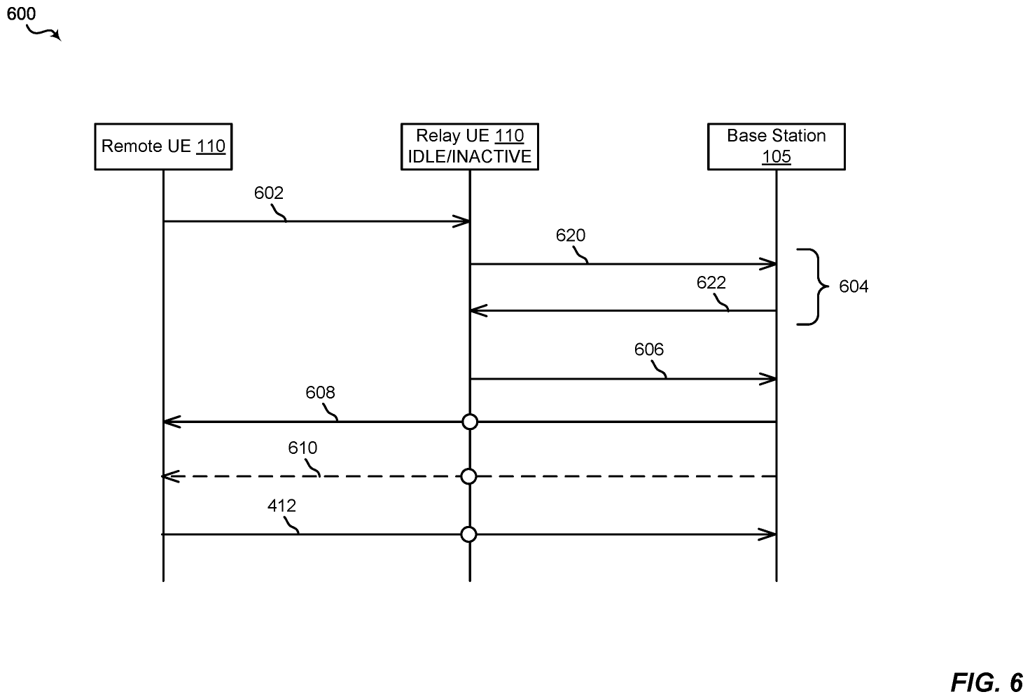

Referring to FIG. 6, example operations for an RRC establishment procedure 600 may include the remote UE 110 transmitting a remote request message 602 to the relay UE 110 while the relay UE 110 is in an idle state (e.g., not in an RRC connected state). The remote request message 602 may include an SRB message (e.g., SRB0 message). In another example, the remote request message 602 may include an RRC setup request message, an RRC resume request message, an RRC resume request message, or an RRC reestablishment request message. In an example, the request message may be transmitted on a default L2 configuration on the PC5 interface (or SL interface).

As the relay UE 110 is in an idle state, the relay UE 110 may perform a relay connection establishment procedure 604 to connect with the base station 105. In an example, the relay connection establishment procedure 604 may include the relay UE 110 transmitting a relay request message 620 to the base station 105 to request a connection between the relay UE 110 and the base station 105. In some examples, the relay request message 620 may include an RRC setup request message or RRC resume request message.

Based on the relay request message 620, the base station 105 may determine RLC configuration information to transmit to the relay UE 110. In an example, the RLC configuration information may include information for configuring a dedicated Uu RLC channel for relaying communications between the base station 105 and the remote UE 110.

In response to the relay request message 620, the base station 105 may transmit a relay configuration message 622 to the relay UE 110 for configuring or setting up the connection between the relay UE 110 and the base station 105. In an example, the relay configuration message 622 may include an RRC setup message or RRC resume message.

In an aspect, the relay configuration message 622 may include an indication of Uu RLC configuration information for the relay UE 110 to relay communications between the remote UE 110 and the base station 105. The Uu RLC configuration information may include information on the dedicated Uu RLC channel.

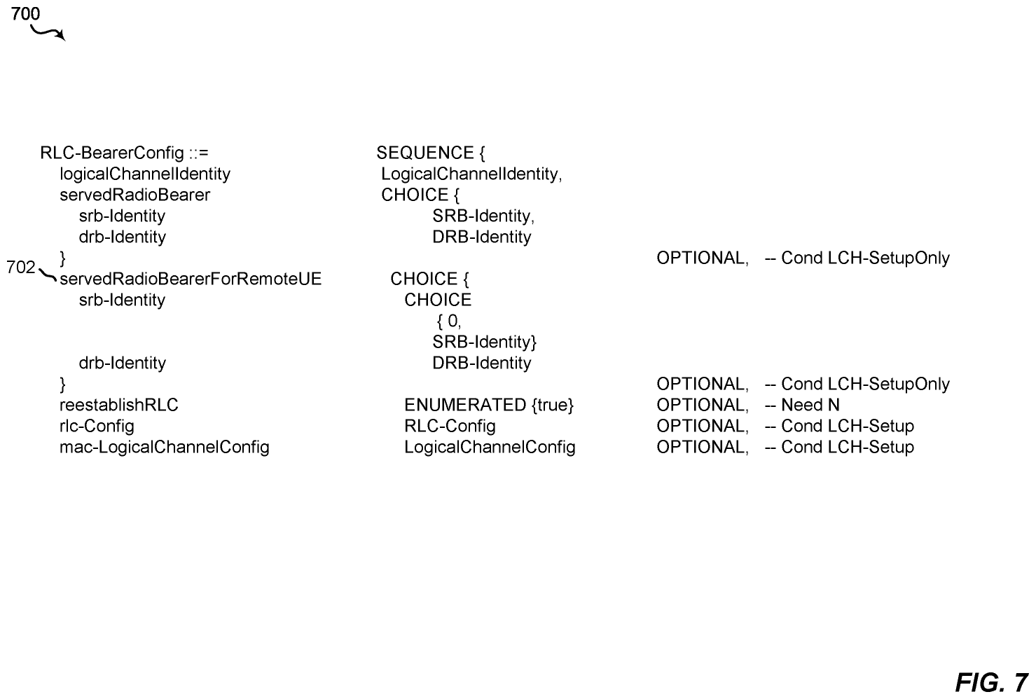

In an example, the base station 105 may know that the relay connection establishment procedure 604 is being performed by the relay UE 110 for a transmission (e.g., remote UE SRB0 message) by the remote UE 110. For example, the relay UE 110 may provide an indication of the remote request message 602 in the relay request message 620. Referring to FIG. 7, an information element (IE) 700 for the base station 105 may include the IE labeled servedRadioBearerForRemoteUE 702 for indicating information on the remote request message 602 to the base station 105. In an example, the IE 700 may use the SRB0 message.

Referring back to FIG. 6, as the connection between the relay UE 110 and the base station 105 is established in the relay connection establishment procedure 604, the relay UE 110 may transmit a remote request message 606 to the base station 105 to request a connection between the remote UE 110 and the base station 105. In some examples, the remote request message 606 may include an RRC setup request message. Further, the remote request message 606 may be transmitted via the dedicated Uu RLC channel, as indicated by the Uu RLC configuration information of the relay configuration message 622.

In an example, the dedicated Uu RLC channel may be a channel dedicated for communications between the remote UE 110 and the base station 105 and may be separate (or different) from a Uu RLC channel used for communications between the relay UE 110 and the base station 105. In other words, the relay UE 110 may be prevented from multiplexing messages on the dedicated Uu RLC channel with SRBs or data radio bearers (DRBs) in a Uu RLC channel between the relay UE 110 and the base station 105. Further, a relayed SRB may have an adaptation layer but an SRB/DRB of the relay UE 110 may not have an adaptation layer.

In response to the remote request message 606, the base station 105 may transmit a remote configuration message 608 to the relay UE 110 and the relay UE 110 may forward the remote configuration message 608 to the remote UE 110. The remote configuration message 608 may be transmitted to the relay UE 110 via the dedicated Uu RLC channel. The remote configuration message 608 may provide information for configuring the relay UE 110 and/or the remote UE 110 for the connection between the remote UE 110 and the base station 105 via the relay UE 110. In an example, the remote configuration message 608 may include an RRC setup message.

Alternatively and optionally, in response to the remote request message 606, the base station 105 may transmit a remote rejection message 610 to the relay UE 110 and the relay UE 110 may forward the remote rejection message 610 to the remote UE 110. The remote rejection message 610 may indicate to the remote UE 110 that the connection between the remote UE 110 and the base station 105 is rejected. The remote rejection message 610 may be transmitted to the relay UE 110 via the dedicated Uu RLC channel. In an example, the remote rejection message 610 may include an RRC reject message.

When the remote configuration message 608 is received, the remote UE 110 may transmit the setup complete message 412 to the base station 105 to indicate a completion of the connection between the remote UE 110 and the base station 105 via the relay UE 110. In this example, the setup complete message 412 may be forwarded from the relay UE 110 to the base station 105 via the dedicated Uu RLC channel.

In another aspect, during operations of FIG. 6, the base station 105 may not provide configuration information of the dedicated Uu RLC channel for relaying in the remote configuration message 608 (e.g., RRC setup message or RRC resume message) for the relay UE 110. In this case, a default Uu RLC channel that is reconfigurable or non-reconfigurable by the base station 105, may be determined by the relay UE 110 for forwarding communications between the remote UE 110 and the base station 105. In an example, information on the default Uu RLC channel may be stored by the relay UE 110 or received in an indication from the base station 105.

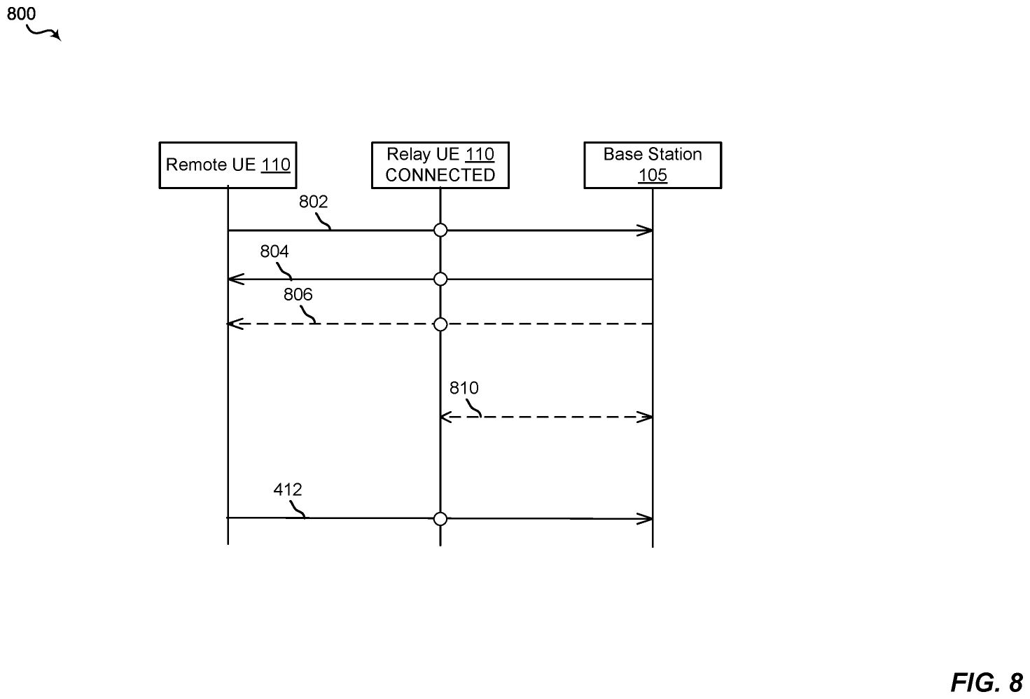

In another aspect, the relay UE 110 may be in a connected state (e.g., RRC connected state) upon reception of a remote request message from the remote UE 110. In this case, the relay UE 110 may not need to perform a connection establishment (e.g., relay connection establishment procedure 604). Instead, the relay UE 110 may perform one of the following examples, referring to FIGS. 8-10, for setting the connection between the remote UE 110 and the base station 105.

Referring to FIG. 8, example operations for an RRC establishment procedure 900 may include the relay UE 110 using a default Uu RLC channel configuration for forwarding communications between the remote UE 110 and the base station 105. In an example, the remote UE 110 may transmit a request message 802 to the relay UE 110 while the relay UE 110 is in an connected state (e.g., connected RRC state with base station 105). The request message 802 may be an SRB message (e.g., SRB0 message).

In response, the relay UE 110 may determine a default Uu RLC channel for forwarding the request message 802 to the base station 105 based on, for example, default RLC information stored by the relay UE 110. Once the default Uu RLC channel is determined, the relay UE 110 may forward the request message 802 to the base station 105.

In response to the request message 802, the base station 105 may transmit a remote configuration message 804 to the relay UE 110 and the relay UE 110 may forward the remote configuration message 804 to the remote UE 110. The remote configuration message 804 may be transmitted to the relay UE 110 via the default Uu RLC channel. The remote configuration message 804 may provide information for configuring the relay UE 110 and/or the remote UE 110 for the connection between the remote UE 110 and the base station 105 via the relay UE 110. In an example, the remote configuration message 804 may include an RRC setup message.

Alternatively and optionally, the base station 105 may transmit a remote rejection message 806 to the relay UE 110 and the relay UE 110 may forward the remote rejection message 806 to the remote UE 110. The remote rejection message 806 may indicate to the remote UE 110 that the connection between the remote UE 110 and the base station 105 is rejected. The remote rejection message 806 may be transmitted to the relay UE 110 via the default Uu RLC channel. In an example, the remote rejection message 806 may include an RRC reject message.

When the remote configuration message 804 is received, the remote UE 110 may transmit the setup complete message 412 to the base station 105 to indicate a completion of the connection between the remote UE 110 and the base station 105 via the relay UE 110. In this example, the setup complete message 412 may be forwarded from the relay UE 110 to the base station 105 via the default Uu RLC channel.

In a first option, the default Uu RLC channel may not be reconfigured by the base station 105. Thus, the Uu RLC channel used for forwarding communications between the remote UE 110 and the base station 105 via the relay UE 110 may remain the same Uu RLC channel for all communications (including setup complete message 412), once determined.

In a second option, the default Uu RLC channel may be reconfigurable by the base station 105. For example, in the second option, after the base station 105 transmits the remote configuration message 804 to the relay UE 110 and the relay UE 110 forwards the remote configuration message 804 to the remote UE 110, the base station 105 and the relay UE 110 may communicate to reconfigure the default Uu RLC channel.

In an example, the base station 105 may transmit reconfiguration information during communications 810 to reconfigure the default Uu RLC channel to a different channel. In an example, the relay UE 110 may receive the reconfiguration information, update the default Uu RLC channel to an updated default Uu RLC channel based on the reconfiguration information, and transmit an indication (e.g., confirmation) of the updates to the default Uu RLC channel to the base station 105 via the communications 810. In an example, the reconfiguration information may include an RRC reconfiguration message to multiplex relay traffic with other remote UEs. In another example, the reconfiguration information may include information such as an identification (e.g., logic channel identification) of an updated Uu RLC channel, settings corresponding to the updated Uu RLC channel, or any other information for assisting the relay UE 110 in updating the default Uu RLC channel to another Uu RLC channel. Further, the communications 810 may include additional messages in the communications 810 to update and confirm the reconfiguration of the default Uu RLC channel.

Once the default Uu RLC channel is reconfigured to the updated default Uu RLC channel, any communications (e.g., setup complete message 412) between the remote UE 110 and the base station 105 may be communicated via the updated default Uu RLC channel.

In an aspect, in the operations performed by FIG. 8, a one-to-one bearer mapping between PC5 RLC channel and the default Uu RLC channel. Therefore, the remote UE 110 may not multiplex SRBs/DRBs of one or more second remote UEs 110 of FIG. 1 (not shown by FIG. 8) or SRBs/DRBs of the relay UE 110.

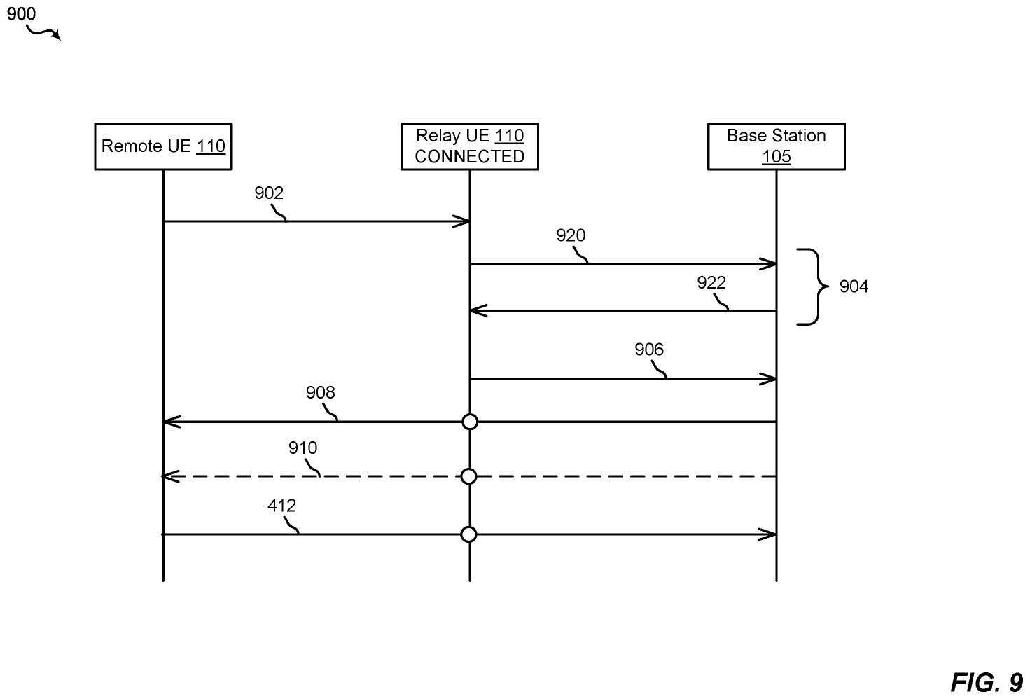

Referring to FIG. 9, example operations for an RRC establishment procedure 900 may include the relay UE 110 using a dedicated Uu RLC channel configuration for forwarding communications between the remote UE 110 and the base station 105.

In an example, the remote UE 110 may transmit a request message 902 to the relay UE 110 while the relay UE 110 is in a connected state (e.g., RRC connected state with the base station 105). The request message 902 may include an SRB message (e.g., SRB0 message). In another example, the request message 902 may include an RRC setup request message, an RRC resume request message, an RRC resume request message, or an RRC reestablishment request message.

In response to the request message 902, the relay UE 110 may perform a connection establishment procedure 904 to connect with the base station 105 and obtain an indication of a dedicated Uu RLC channel for relaying communications between the remote UE 110 and the base station.

During the connection establishment procedure 904, the relay UE 110 may transmit an identification message 920 including identification information of the remote UE 110. The identification information may include, for example, a remote UE local identification and/or a cause value (e.g., RRC establishment or RRC resume). In an example, the identification message 920 may include an SL UE information NR message.

Based on the identification message 920, the base station 105 may determine RLC configuration information to transmit to the relay UE 110. In an example, the RLC configuration information may include information for configuring a dedicated Uu RLC channel for relaying communications between the base station 105 and the remote UE 110.

In an example, the dedicated Uu RLC channel may be a channel dedicated for communications between the remote UE 110 and the base station 105 and may be separate (or different) from a Uu RLC channel used for communications between the relay UE 110 and the base station 105. In other words, the relay UE 110 may be prevented from multiplexing messages on the dedicated Uu RLC channel with SRBs or data radio bearers (DRBs) in a Uu RLC channel between the relay UE 110 and the base station 105. Further, a relayed SRB may have an adaptation layer but an SRB/DRB of the relay UE 110 may not have an adaptation layer.

In response to the identification message 920, the base station 105 may transmit a configuration message 922 to the relay UE 110 for configuring or setting up the dedicated Uu RLC channel. In an example, the configuration message 922 may include an RRC reconfiguration message.

When the configuration message 922 is received by the relay UE 110, the relay UE 110 may be configured to relay all messages between the base station 105 and the remote UE 110 via the dedicated Uu RLC channel. For example, the relay UE 110 may forward the request message 902 (indicated by request message 906) to the base station 105 via the dedicated Uu RLC channel, the base station 105 may respond to the request message 906 by transmitting (a) a remote configuration message 908 or (b) alternatively and optionally, a remote rejection message 910 to the relay UE 110 via the dedicated Uu RLC channel and the relay UE 110 may forward the respective message to the remote UE 110.

In an example, the remote configuration message 908 may provide information for configuring the remote UE 110 for the connection between the remote UE 110 and the base station 105 via the relay UE 110. In an example, the remote configuration message 908 may include an RRC setup message. In another example, the remote rejection message 910 may indicate to the remote UE 110 that the connection between the remote UE 110 and the base station 105 is rejected. The remote rejection message 910 may include an RRC reject message.

When the remote configuration message 908 is received, the remote UE 110 may transmit the setup complete message 412 to the base station 105 to indicate a completion of the connection between the remote UE 110 and the base station 105 via the relay UE 110. In this example, the setup complete message 412 may be forwarded from the relay UE 110 to the base station 105 via the dedicated Uu RLC channel.

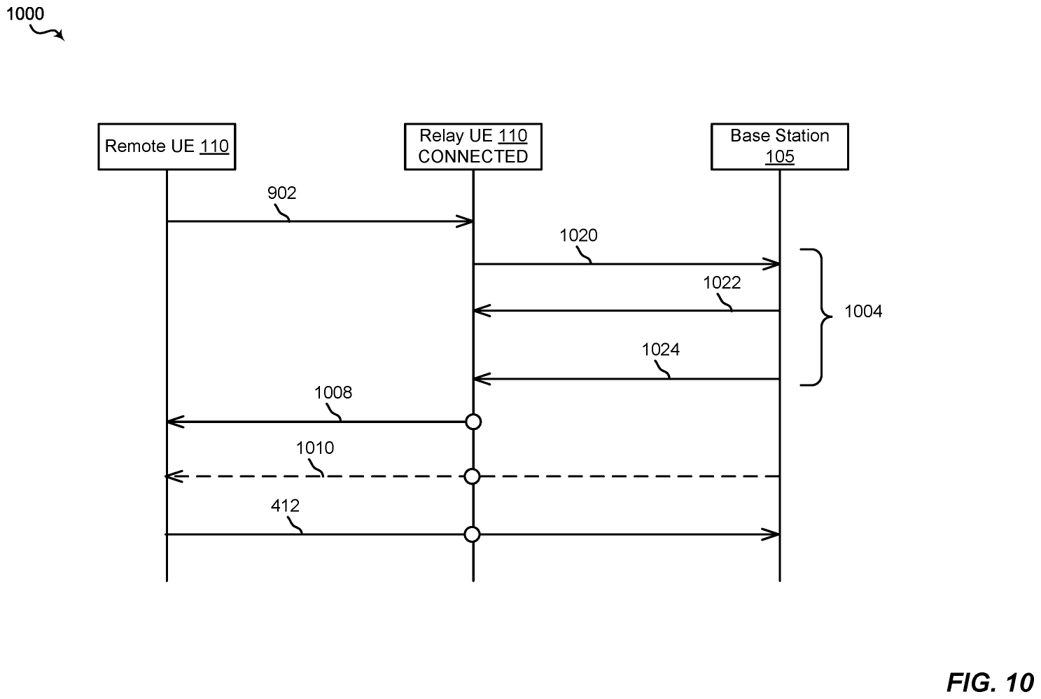

Referring to FIG. 10, example operations for an RRC establishment procedure 1000 may include alternative operations for the relay UE 110 to use a dedicated Uu RLC channel configuration for forwarding communications between the remote UE 110 and the base station 105.

In response to the request message 902, the relay UE 110 may perform a connection establishment procedure 1004 to connect with the base station 105 and obtain an indication of a dedicated Uu RLC channel for relaying communications between the remote UE 110 and the base station.

During the connection establishment procedure 1004, the relay UE 110 may transmit a UL information message 1020 including, for example, UL information for a multi-radio access technology (RAT) dual connectivity (MRDC). In this example, the UL information message 1020 may be transmitted as a container for the request message 902. For example, the relay UE 110 may use its own SRB1 message as a container for forwarding the SRB0 message (e.g., request message 902) to the base station 105.

Based on the UL information message 1020 and as the request message 902 may include identification of the remote UE 110, the base station 105 may determine RLC configuration information to transmit to the relay UE 110. In an example, the RLC configuration information may include information for configuring a dedicated Uu RLC channel for relaying communications between the base station 105 and the remote UE 110.

As disclosed herein, the dedicated Uu RLC channel may be a channel dedicated for communications between the remote UE 110 and the base station 105 and may be separate (or different) from a Uu RLC channel used for communications between the relay UE 110 and the base station 105.

In response to the UL information message 1020, the base station 105 may transmit a configuration message 1022 to the relay UE 110 for configuring or setting up the dedicated Uu RLC channel. In an example, the configuration message 1022 may include an RRC reconfiguration message.

The base station 105 may also transmit a DL information message 1024 to the relay UE 110 including, for example, DL information for a MRDC. In this example, the DL information message 1024 may be transmitted as a container for a configuration message (e.g., RRC setup message). When the DL information message 1024 is received by the relay UE 110, the relay UE 110 may transmit, to the remote UE 110, a remote configuration message 1008 for configuring the remote UE 110.

Further, the relay UE 110 may be configured to relay all messages between the base station 105 and the remote UE 110 via the dedicated Uu RLC channel. For example, the relay UE 110 may forward the setup complete message 412 from the remote UE 110 to the base station 105 via the dedicated Uu RLC channel.

Alternatively and optionally, instead of transmitting the DL information message 1024, the base station 105 may transmit a remote rejection message 1010 via the dedicated Uu RLC channel to indicate to the remote UE 110 that the connection between the remote UE 110 and the base station 105 is rejected. The remote rejection message 1010 may include an RRC reject message.

Implementation of the operations disclosed by FIGS. 8 and 10, as compared to the operations of FIG. 9, may improve latency by not using two RRC messages.

In an aspect, for all operations of FIGS. 6 and 8-10, a same Uu RLC channel may be used for a DL response RRC message. In an first example, a same dedicated Uu RLC channel from the base station 105 may be used for delivering, for example, an RRC setup message, an RRC resume message, or an RRC reestablishment message. In a second example, for the operations of FIGS. 8, the same default Uu RLC channel may be used for delivery of an RRC setup message, an RRC resume message, or an RRC reestablishment message.

In another aspect, the same dedicated Uu RLC channel from the base station 105 may be used for delivery of an RRC setup message, an RRC resume message, or an RRC reestablishment message.

In another aspect, a response RRC message (an RRC setup message, an RRC resume message, or an RRC reestablishment message.) may also be included in an RRC reconfiguration message towards the relay UE 110 as a container, and configuration information for the dedicated Uu RLC channel may also be included in the response RRC message.

In an aspect, when both the SL (or PC5) RLC channel and the Uu RLC channel use a default configuration for the Uu RLC channel, a DL and UL Uu adaptation layer header may be absent from any messages because for a UL adaptation layer, the destination may always be the base station 105, and for a DL adaptation layer, the destination may be the remote UE 110, which can be implicitly identified by the relay UE 110 via paired UL SRB/DRB. In other words, the UL SRB/DRB may use the same identification of the UL SRB/DRB.

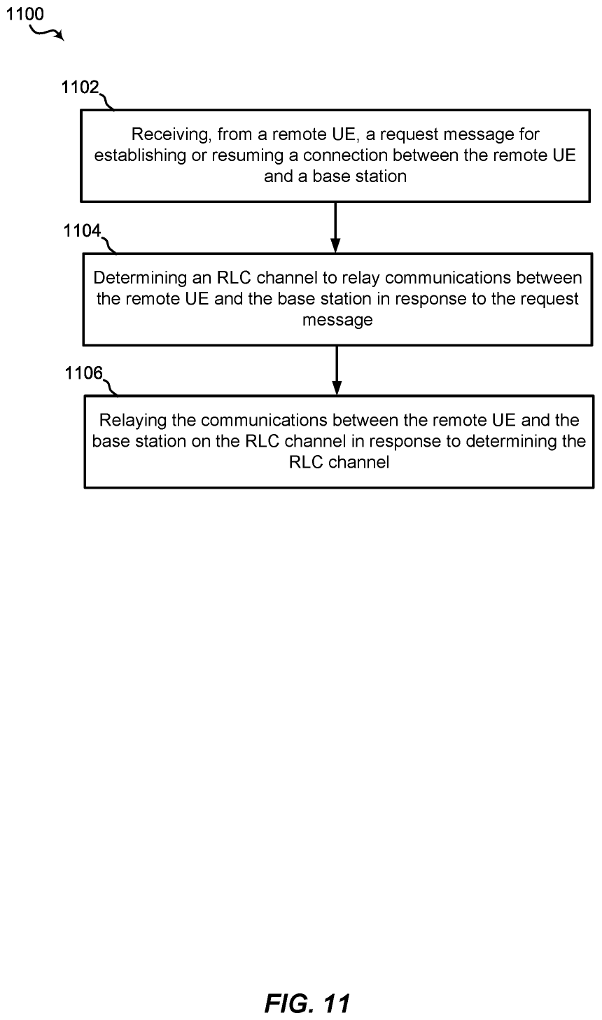

Referring to FIG. 11, an example of a method 1100 for wireless communications may be performed by the relay UE 110 of the wireless communication network 100. For example, operations of the method 1100 may be performed by the relay component 142, the modem 140, the transceiver 202, the processor 212, the memory 216, and or any other component/subcomponent of the UE 110.

At block 1102, the method 1100 may include receiving, from a remote UE, a request message for establishing or resuming a connection between the remote UE and a base station. For example, the relay component 142, the modem 140, the transceiver 202, the processor 212, and/or the memory 216 of the UE 110, and/or one or more additional components/subcomponents of the UE 110 may be configured to or may comprise means for receiving, from a remote UE, a request message for establishing or resuming a connection between the remote UE and a base station.

For example, the receiving the request message at block 1102 may include receiving by the relay component 142, the modem 140, the transceiver 202, the processor 212, and/or the memory 216 of the UE 110, via, for example, the antenna 265 and the RF front end 288, from the remote UE 110, the message 602 of FIG. 6, the message 802 of FIG. 8, or the message 902 of FIG. 9 or FIG. 10 for establishing or resuming a connection between the remote UE 110 and the base station 105.

At block 1104, the method 1100 may include determining an RLC channel to relay communications between the remote UE and the base station in response to the request message. For example, the relay component 142, the modem 140, the transceiver 202, the processor 212, and/or the memory 216 of the UE 110, and/or one or more additional components/subcomponents of the UE 110 may be configured to or may comprise means for determining an RLC channel to relay communications between the remote UE and the base station in response to the request message.

For example, the determining the RLC channel at block 1104 may include determining, by the relay component 142, the modem 140, the transceiver 202, the processor 212, and/or the memory 216 of the UE 110, the Uu RLC channel to relay communications between the remote UE 110 and the base station 105 in response to the message 602 of FIG. 6, the message 802 of FIG. 8, or the message 902 of FIG. 9 or FIG. 10 (request message).

In an example, the determination of the Uu RLC channel may be based on, for example, a state (e.g., idle or connected) state of the relay UE 110. Further, the Uu RLC channel may be determined to be one of a default Uu RLC channel (e.g., reconfigurable or non-reconfigurable by the base station 105) or a dedicated Uu RLC channel for forwarding communications between the remote UE 110 and the base station 105 via the relay UE 110 that is separate from a Uu RLC channel used for communications between the relay UE 110 and the base station 105.

At block 1106, the method 1100 may include relaying the communications between the remote UE and the base station on the RLC channel in response to determining the RLC channel. For example, the relay component 142, the modem 140, the transceiver 202, the processor 212, and/or the memory 216 of the UE 110, and/or one or more additional components/subcomponents of the UE 110 may be configured to or may comprise means for relaying the communications between the remote UE and the base station on the RLC channel in response to determining the RLC channel.

For example, the relaying the communications at block 1106 may include relaying, by the relay component 142, the modem 140, the transceiver 202, the processor 212, and/or the memory 216 of the UE 110, relaying the setup complete message 412 (communications) between the remote UE 110 and the base station 105 on the Uu RLC channel (e.g., default or dedicated Uu RLC channel) in response to determining the Uu RLC channel.

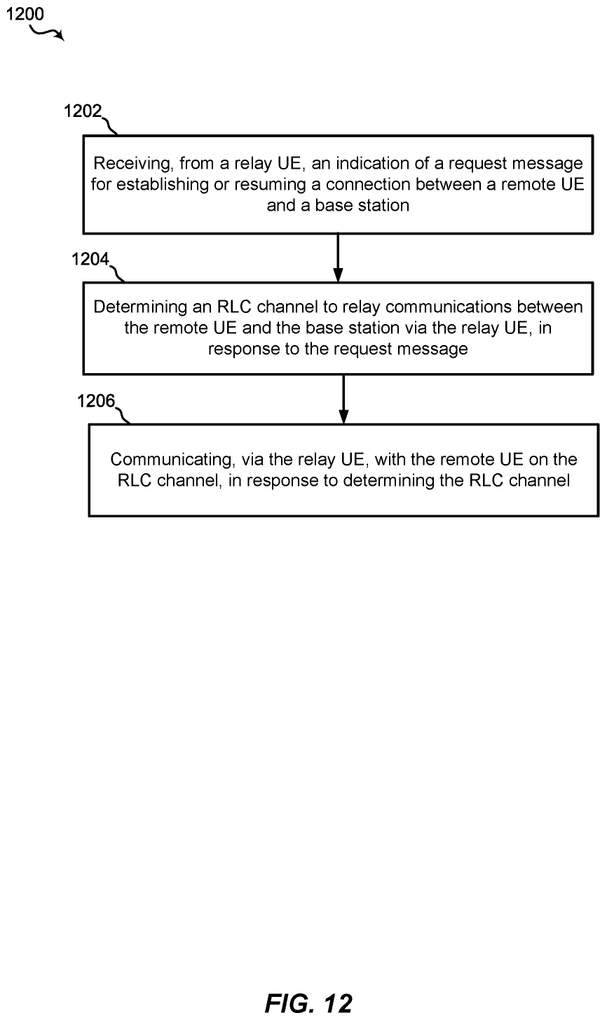

Referring to FIG. 12, an example of a method 1200 for wireless communications may be performed by the base station 105 of the wireless communication network 100. For example, operations of the method 1200 may be performed by the RLC component 146, the modem 144, the transceiver 302, the processor 312, the memory 316, and or any other component/subcomponent of the base station 105.

At block 1202, the method 1200 may include receiving, from a relay UE, an indication of a request message for establishing or resuming a connection between a remote UE and a base station. For example, the RLC component 146, the modem 144, the transceiver 302, the processor 312, and/or the memory 316 of the base station 105, and/or one or more additional components/subcomponents of the base station 105 may be configured to or may comprise means for receiving, from a relay UE, an indication of a request message for establishing or resuming a connection between a remote UE and a base station.

For example, the receiving the request message at block 1202 may include receiving by the RLC component 146, the modem 144, the transceiver 302, the processor 312, and/or the memory 316 of the base station 105, via, for example, the antenna 265 and the RF front end 288, from the relay UE 110, an indication of the message 602 of FIG. 6, the message 802 of FIG. 8, or the message 902 of FIGS. 9 and 10 for establishing or resuming a connection between the remote UE 110 and the base station 105.

At block 1204, the method 1200 may include determining an RLC channel to relay communications between the remote UE and the base station via the relay UE, in response to the request message. For example, the RLC component 146, the modem 144, the transceiver 302, the processor 312, and/or the memory 316 of the base station 105, and/or one or more additional components/subcomponents of the base station 105 may be configured to or may comprise means for determining an RLC channel to relay communications between the remote UE and the base station via the relay UE, in response to the request message.

For example, the determining the RLC channel at block 1204 may include determining, by the RLC component 146, the modem 144, the transceiver 302, the processor 312, and/or the memory 316 of the base station 105, the Uu RLC channel to relay communications between the remote UE 110 and the base station 105 via the relay UE 110, in response to the message 602 of FIG. 6, the message 802 of FIG. 8, or the message 902 of FIG. 9 or FIG. 10 (request message).

In an example, the determination of the Uu RLC channel may be based on a state (e.g., idle or connected) state of the relay UE 110. Further, the Uu RLC channel may be determined to be one of a default Uu RLC channel (e.g., reconfigurable or non-reconfigurable by the base station 105) or a dedicated Uu RLC channel for forwarding communications between the remote UE 110 and the base station 105 via the relay UE 110 that is separate from a Uu RLC channel used for communications between the relay UE 110 and the base station 105.

At block 1206, the method 1200 may include communicating, via the relay UE, with the remote UE on the RLC channel, in response to determining the RLC channel. For example, the RLC component 146, the modem 144, the transceiver 302, the processor 312, and/or the memory 316 of the base station 105, and/or one or more additional components/subcomponents of the base station 105 may be configured to or may comprise means for communicating, via the relay UE, with the remote UE on the RLC channel, in response to determining the RLC channel.

For example, the communicating with the remote UE at block 1206 may include communicating, by the RLC component 146, the modem 144, the transceiver 302, the processor 312, and/or the memory 316 of the base station 105, via the relay UE 110, with the remote UE 110 on the Uu RLC channel to communicate the setup complete message 412, in response to determining the RLC channel.

### Additional Implementations

An example method of wireless communication for a relay UE, comprising: receiving, from a remote UE, a request message for establishing or resuming a connection between the remote UE and a base station; determining an RLC channel to relay communications between the remote UE and the base station in response to the request message; and relaying the communications between the remote UE and the base station on the RLC channel in response to determining the RLC channel.

The above example method, further comprising: determining a current state of the relay UE, wherein the current state is one of an idle state, an inactive state, or a connected state, and wherein the RLC channel is determined based on the current state.

One or more of the above example methods, further comprising: transmitting, to the base station, an indication of the request message, in response to the current state of the relay UE being the idle state or the inactive state; and receiving, from the base station, RLC configuration information indicating a dedicated Uu RLC channel for relaying signaling of the remote UE, in response to the indication of the request message, wherein the RLC channel is determined based on the dedicated Uu RLC channel.

One or more of the above example methods, wherein the dedicated Uu RLC channel is a Uu RLC channel between the remote UE and the base station, the dedicated Uu RLC channel is different from a second Uu RLC channel for communications between the relay UE and the base station, and the dedicated Uu RLC channel does not multiplex with a signaling radio bearer (SRB) or a data radio bearer (DRB) of the relay UE.

One or more of the above example methods, wherein the dedicated Uu RLC channel is associated with a signal radio bearer (SRB) 0 message or the remote UE via radio resource control (RRC) signaling.

One or more of the above example methods, further comprising: obtaining RLC information stored by the relay UE and corresponding to a default Uu RLC channel for relaying signaling of the remote UE, in response to the current state of the relay UE being the connected state, wherein the RLC channel is the default Uu RLC channel with a fixed logical channel identification (LCID) or a fixed configuration.

One or more of the above example methods, wherein the default Uu RLC channel is non-reconfigurable by the base station.

One or more of the above example methods, wherein the default Uu RLC channel is reconfigurable by the base station via a subsequent radio resource control (RRC) reconfiguration message.

One or more of the above example methods, wherein the default Uu RLC channel has a one-to-one bearer mapping with a sidelink RLC channel.

One or more of the above example methods, wherein the default Uu RLC channel does not multiplex with a signal radio bearer (SRB) or a data radio bearer (DRB) of the relay UE.

One or more of the above example methods, wherein the default Uu RLC channel does not multiplex with a signal radio bearer (SRB) or a data radio bearer (DRB) of a second remote UE.

One or more of the above example methods, further comprising: transmitting, to the base station, an indication of the request message, in response to the current state of the relay UE being the connected state; and receiving, from the base station, RLC configuration information indicating a dedicated Uu RLC channel for relaying signaling of the remote UE, in response to the indication of the request message, wherein the RLC channel is determined based on the dedicated Uu RLC channel.

One or more of the above example methods, wherein the indication of the request message comprises identification information corresponding to the remote UE or a cause value indicating a current state of the remote UE.

One or more of the above example methods, further comprising: transmitting, to the base station, an indication of the request message using a relay-to-base station message as a container for the indication, in response to the current state of the relay UE being the connected state; and receiving, from the base station, a confirmation message, in response to the request message, wherein the RLC channel is determined based on the confirmation message.

One or more of the above example methods, wherein the confirmation message includes RLC configuration information indicating the RLC channel for relaying signaling of the remote UE.

One or more of the above example methods, wherein the confirmation message indicates to the relay UE to use a default Uu RLC channel as the RLC channel for relaying signaling of the remote UE, the default Uu RLC channel is indicated by RLC information stored by the relay UE, and the default Uu RLC channel includes a fixed logical channel identification (LCID) or a fixed configuration.

One or more of the above example methods, further comprising: receiving, from the base station, a downlink (DL) response message via the RLC channel with a same RLC configuration as an uplink (UL) request message corresponding to the DL response message.

One or more of the above example methods, further comprising: omitting an adaptation layer header of the communications between the remote UE and the base station, in response to the RLC channel and a sidelink (SL) RLC channel using a default RLC configuration.

An example relay UE comprising: a memory storing instructions; and one or more processors coupled with the memory and configured to perform one or more of the above example methods.

An example apparatus for wireless communication, comprising: means for performing one or more of the above example methods.

An example computer-readable medium storing computer executable code, comprising code to: perform one or more of the above example methods.

An example second method of wireless communication for a base station, comprising: receiving, from a relay user equipment (UE), an indication of a request message for establishing or resuming a connection between a remote UE and a base station; determining a radio link control (RLC) channel to relay communications between the remote UE and the base station via the relay UE, in response to the request message; and communicating, via the relay UE, with the remote UE on the RLC channel, in response to determining the RLC channel.

The above second method, further comprising: transmitting, to the relay UE, RLC configuration information indicating a dedicated Uu RLC channel for the relay UE to use as the RLC channel for relaying signaling of the remote UE, in response to the determining the RLC channel, wherein the communicating is further in response to the transmitting the RLC configuration information.

One or more of the above example second methods, wherein the dedicated Uu RLC channel is between the remote UE and the base station, the dedicated Uu RLC channel is different from a second Uu RLC channel for communications between the relay UE and the base station, and the dedicated Uu RLC channel does not multiplex with a signaling radio bearer (SRB) or a data radio bearer (DRB) of the relay UE.

One or more of the above example second methods, wherein the determining the RLC channel comprises: obtaining RLC information stored by the base station and corresponding to a default Uu RLC channel for relaying signaling of the remote UE, wherein the RLC channel is the default Uu RLC channel with a fixed logical channel identification (LCID) or a fixed configuration.

One or more of the above example second methods, wherein the default Uu RLC channel is non-reconfigurable by the base station.

One or more of the above example second methods, wherein the default Uu RLC channel is reconfigurable by the base station via a subsequent radio resource control (RRC) reconfiguration message.

One or more of the above example second methods, wherein the default RLC channel has a one-to-one bearer mapping with a sidelink RLC channel used by the relay UE and the remote UE.

One or more of the above example second methods, wherein the default Uu RLC channel does not multiplex with with a signal radio bearer (SRB) or a data radio bearer (DRB) of the relay UE.

One or more of the above example second methods, wherein the default Uu RLC channel does not multiplex with a signal radio bearer (SRB) or a data radio bearer (DRB) of a second remote UE.

One or more of the above example second methods, wherein the indication of the request message comprises identification information corresponding to the remote UE or a cause value indicating current state of the remote UE, and the method further comprises: transmitting, to the relay UE, RLC configuration information indicating a dedicated Uu RLC channel for the relay UE to use as the RLC channel for relaying signaling of the remote UE, in response to the determining the RLC channel, wherein the communicating is further in response to the transmitting the RLC configuration information.

One or more of the above example second methods, further comprising: receiving, from the relay UE, the indication of the request message in a relay-to-base station message used as a container for the indication; and transmitting, to the relay UE, a confirmation message, in response to the request message, wherein the RLC channel is determined based on the indication of the request message.

One or more of the above example second methods, wherein the confirmation message includes RLC configuration information indicating the RLC channel for relaying signaling of the remote UE.

One or more of the above example second methods, wherein the confirmation message indicates to the relay UE to use a default Uu RLC channel as the RLC channel for relaying signaling of the remote UE, and the default Uu RLC channel includes a fixed Logical Channel ID (LCID) or a fixed configuration.

One or more of the above example second methods, further comprising: transmitting, to the relay UE, a downlink (DL) response message via the RLC channel with a same RLC configuration as an uplink (UL) request message corresponding to the DL response message.

One or more of the above example second methods, further comprising: omitting an adaptation layer header of the communications between the remote UE and the base station, in response to the RLC channel and a sidelink (SL) RLC channel using a default RLC configuration.

An example relay UE comprising: a memory storing instructions; and one or more processors coupled with the memory and configured to perform one or more of the above example methods.

An example apparatus for wireless communication, comprising: means for performing one or more of the above example methods.

An example computer-readable medium storing computer executable code, comprising code to: perform one or more of the above example methods.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method of wireless communication for a relay user equipment (UE), comprising:
receiving, from a remote UE, a request message for establishing or resuming a connection between the remote UE and a base station;
determining a radio link control (RLC) channel to relay communications between the remote UE and the base station in response to the request message; and
relaying the communications between the remote UE and the base station on the RLC channel in response to determining the RLC channel.

2. The method of claim 1, further comprising:
determining a current state of the relay UE,
wherein the current state is one of an idle state, an inactive state, or a connected state, and wherein the RLC channel is determined based on the current state.

3. The method of claim 2, further comprising:
transmitting, to the base station, an indication of the request message, in response to the current state of the relay UE being the idle state or the inactive state; and
receiving, from the base station, RLC configuration information indicating a dedicated Uu RLC channel for relaying signaling of the remote UE, in response to the indication of the request message,
wherein the RLC channel is determined based on the dedicated Uu RLC channel.

4. The method of claim 3, wherein the dedicated Uu RLC channel is a Uu RLC channel between the remote UE and the base station, the dedicated Uu RLC channel is different from a second Uu RLC channel for communications between the relay UE and the base station, and the dedicated Uu RLC channel does not multiplex with a signaling radio bearer (SRB) or a data radio bearer (DRB) of the relay UE.

5. The method of claim 3, wherein the dedicated Uu RLC channel is associated with a signal radio bearer (SRB) 0 message or the remote UE via radio resource control (RRC) signaling.

6. The method of claim 2, further comprising:
obtaining RLC information stored by the relay UE and corresponding to a default Uu RLC channel for relaying signaling of the remote UE, in response to the current state of the relay UE being the connected state,
wherein the RLC channel is the default Uu RLC channel with a fixed logical channel identification (LCD) or a fixed configuration.

7. The method of claim 6, wherein the default Uu RLC channel is non-reconfigurable by the base station.

8. The method of claim 6, wherein the default Uu RLC channel is reconfigurable by the base station via a subsequent radio resource control (RRC) reconfiguration message.

9. The method of claim 6, wherein the default Uu RLC channel has a one-to-one bearer mapping with a sidelink RLC channel.

10. The method of claim 6, wherein the default Uu RLC channel does not multiplex with a signal radio bearer (SRB) or a data radio bearer (DRB) of the relay UE.

11. The method of claim 6, wherein the default Uu RLC channel does not multiplex with a signal radio bearer (SRB) or a data radio bearer (DRB) of a second remote UE.

12. The method of claim 2, further comprising:
transmitting, to the base station, an indication of the request message, in response to the current state of the relay UE being the connected state; and
receiving, from the base station, RLC configuration information indicating a dedicated Uu RLC channel for relaying signaling of the remote UE, in response to the indication of the request message,
wherein the RLC channel is determined based on the dedicated Uu RLC channel.

13. The method of claim 12, wherein the indication of the request message comprises identification information corresponding to the remote UE or a cause value indicating a current state of the remote UE.

14. The method of claim 2, further comprising:
transmitting, to the base station, an indication of the request message using a relay-to-base station message as a container for the indication, in response to the current state of the relay UE being the connected state; and
receiving, from the base station, a confirmation message, in response to the request message,
wherein the RLC channel is determined based on the confirmation message.

15. The method of claim 14, wherein the confirmation message includes RLC configuration information indicating the RLC channel for relaying signaling of the remote UE.

16. The method of claim 14, wherein the confirmation message indicates to the relay UE to use a default Uu RLC channel as the RLC channel for relaying signaling of the remote UE, the default Uu RLC channel is indicated by RLC information stored by the relay UE, and the default Uu RLC channel includes a fixed logical channel identification (LCD) or a fixed configuration.

17. The method of claim 1, further comprising:
receiving, from the base station, a downlink (DL) response message via the RLC channel with a same RLC configuration as an uplink (UL) request message corresponding to the DL response message.

18. The method of claim 1, further comprising:
omitting an adaptation layer header of the communications between the remote UE and the base station, in response to the RLC channel and a sidelink (SL) RLC channel using a default RLC configuration.

19. A method of wireless communication for a base station, comprising:
receiving, from a relay user equipment (UE), an indication of a request message for establishing or resuming a connection between a remote UE and a base station;
determining a radio link control (RLC) channel to relay communications between the remote UE and the base station via the relay UE, in response to the request message; and
communicating, via the relay UE, with the remote UE on the RLC channel, in response to determining the RLC channel.

20. The method of claim 19, further comprising:
transmitting, to the relay UE, RLC configuration information indicating a dedicated Uu RLC channel for the relay UE to use as the RLC channel for relaying signaling of the remote UE, in response to the determining the RLC channel,
wherein the communicating is further in response to the transmitting the RLC configuration information.

21. The method of claim 20, wherein the dedicated Uu RLC channel is between the remote UE and the base station, the dedicated Uu RLC channel is different from a second Uu RLC channel for communications between the relay UE and the base station, and the dedicated Uu RLC channel does not multiplex with a signaling radio bearer (SRB) or a data radio bearer (DRB) of the relay UE.

22. The method of claim 19, wherein the determining the RLC channel comprises:
obtaining RLC information stored by the base station and corresponding to a default Uu RLC channel for relaying signaling of the remote UE, wherein the RLC channel is the default Uu RLC channel with a fixed logical channel identification (LCID) or a fixed configuration.

23. The method of claim 22, wherein the default Uu RLC channel is non-reconfigurable by the base station.

24. The method of claim 22, wherein the default Uu RLC channel is reconfigurable by the base station via a subsequent radio resource control (RRC) reconfiguration message.

25. The method of claim 22, wherein the default RLC channel has a one-to-one bearer mapping with a sidelink RLC channel used by the relay UE and the remote UE.

26. The method of claim 22, wherein the default Uu RLC channel does not multiplex with a signal radio bearer (SRB) or a data radio bearer (DRB) of the relay UE.

27. The method of claim 22, wherein the default Uu RLC channel does not multiplex with a signal radio bearer (SRB) or a data radio bearer (DRB) of a second remote UE.

28. The method of claim 19, wherein the indication of the request message comprises identification information corresponding to the remote UE or a cause value indicating current state of the remote UE, and the method further comprises:
transmitting, to the relay UE, RLC configuration information indicating a dedicated Uu RLC channel for the relay UE to use as the RLC channel for relaying signaling of the remote UE, in response to the determining the RLC channel,
wherein the communicating is further in response to the transmitting the RLC configuration information.

29.-36. (canceled)

37. A relay user equipment (UE) for wireless communication, comprising:
at least one processor; and
memory coupled with the at least one processor, the memory including instructions executable by the at least one processor, individually or in any combination, to cause the relay UE to:
receive, from a remote UE, a request message for establishing or resuming a connection between the remote UE and a base station;
determine a radio link control (RLC) channel to relay communications between the remote UE and the base station in response to the request message; and
relay the communications between the remote UE and the base station on the RLC channel in response to determining the RLC channel.

38. A base station for wireless communication, comprising:
at least one processor; and
memory coupled with the at least one processor, the memory including instructions executable by the at least one processor, individually or in any combination, to cause the base station to:
receive, from a relay user equipment (UE), an indication of a request message for establishing or resuming a connection between a remote UE and a base station;
determine a radio link control (RLC) channel to relay communications between the remote UE and the base station via the relay UE, in response to the request message; and
communicate, via the relay UE, with the remote UE on the RLC channel, in response to determining the RLC channel.
